(19) United States
(12) Patent Application Publication
(10) Pub. No.: US 2005/0230309 A1
(43) Pub. Date: Oct. 20, 2005

(54) Functional water with deodorization activity and sterilization activity against multi-drug resistent bacteria, and a preparation method thereof

(76) Inventors: Park Lee, Gyeonggi-Do (KR); In-Chung Song, Seoul (KR)

Correspondence Address: BARLOW, JOSEPHS & HOLMES, LTD., 101 DYER STREET, 5TH FLOOR, PROVIDENCE, RI, 02903, US

(21) Appl. No.: 10/519,608

(22) PCT Filed: Jun. 27, 2003
(86) PCT No.: PCT/KR03/01272

§ 371 Date: Dec. 28, 2004

(30) Foreign Application Priority Data
Jul. 5, 2002 (KR) 10 2002 0038818

(51) Int. Cl. C02F 3/30

(52) U.S. Cl. 210/605

(57) ABSTRACT

Disclosed is pollution-free functional water with deodorization activity and sterilization activity against multi-drug resistant bacteria. In the present invention, the functional water is prepared by treating a solution which contains mixture of pulverized molasses, soybean and bamboo through decomposition tank, a first precipitation tank, a bio-tank, a second precipitation tank and filter. Also, disclosed in a method for preparing the functional water.

### CROSS-REFERENCE TO RELATED APPLICATION

This application claims the benefit of PCT International Application No. PCT/KR2003/001272 under 35 U.S.C. §371.

### BACKGROUND OF THE INVENTION

1. Field of the Invention

The present invention relates to pollution-free functional water with deodorization activity and sterilization activity against multi-drug resistant bacteria and a method for producing the same, and more particularly, it relates to pollution-free functional water which is obtainable by treating a solution containing mixture of pulverized molasses, soybean and bamboo through a decomposition tank, a first precipitation tank, a bio-tank, second precipitation tank and a filter and a method for producing the same.

2. Prior Art

Reckless use of various antibiotics and agricultural chemicals lead appearance of various drug resistant bacteria such as MRSA(Methicillin Resistant Staphylococcus Aureus), VRSA(Vancomycin Resistant Staphylococcus Aureus), VRE(Vancomycin Resistant Enterococci), E.coli O-157(Enterohemorrhagic E. coli) and create many problems such as oxidation of soil due to long-term use of conventional chemical fertilizers and generation of a large quantity of toxic gases in soil.

On the other hand, organic ingredients of organic fertilizers prevent loss of various effective ingredients and also have effects as a fertilizer for improvement of soil. In general, the reason why organic fertilizers are used, though plants absorb inorganic substances but do not absorb organic substances is that the used organic substances become food for microorganisms habiting at root zone and decomposed into inorganic substances by the microorganisms and the decomposed inorganic substances consequently can be absorbed by plants. Therefore, properties of an added organic fertilizer may cause change in metabolic functions of microorganisms habiting at root zone. That is, the organic fertilizers are environmental substances of microorganisms habiting at root zone. Accordingly, when an organic fertilizer which a harmful microorganism lives on is used, blight takes place and insects which prefers metabolic products of pathogenic microorganisms come out, while when there is no environment for harmful bacteria to live in and organic fertilizer suitable for useful bacterial to live on is used, growth of plants can be promoted without damages by blight and harmful insects.

Typically, human beings have used composts prepared by fermenting organic substances from a long time ago. Reclamation is most generally used as a method for treating organic waste but has problems of production of leachate and offensive odor.

Meanwhile, nature has originally natural purification functions and denaturalization of organic substances in nature is largely classified into two directions.

That is, the denaturalization of organic substances are generally directed into two totally different directions of low molecularization and high (macro) molecularization. The more general direction of denaturalization of these organic substances is the high (macro) molecularization.

The low molecularization can be seen in decomposition of organic substances in the manner of enzymatic decomposition but its quantitative proportion is small. On the other hand, the denaturalization into the high (macro) molecularization is the main denaturalization cycle occurring in nature and found in innumerable cases, including for example, soil of polycondensates comprising structurally connected organic substances and inorganic substances, coal type polycondensates such as coal, peat, brown coal, lignite etc., base sludge of swamps and lakes.

Also, when a substance having a large content of siliceous power is added to the reaction, humification occurs, whereby macromolecularization and sludge formation develop.

The humification of organic substances occurring in nature progresses slowly over a wide area but can be further promoted by repeatedly adding a silicate having an activity superior to that of silicates existing in soil or rocks at a time when organic substances are added.

### SUMMARY OF THE INVENTION

Accordingly, the present invention has been made to solve the above-described problems, and it is an object of the present invention to provide functional water which is rich in both metabolic products of microorganisms prepared in decomposition of organic substances and resynthesis products such as various vitamins and growth promoting substances, and has antibiotic and antibacterial effects against various resistant bacterial by supplying humus substances at a high concentration to provide an environment where a group of microorganisms living in nature can decompose organic substances such as carbohydrate, protein, lignin, tannin and the like and making the inside of a reactor into a concentrated natural environment to accelerate self-purification of organic substances in nature which are slowly progressed over a wide area.

According to the method for producing functional water of the present invention, organic substances contained in an organic aqueous solution are activated in a culture tank filled with humus soil and active silicates, passed through a decomposition tank, in which they are decomposed by microorganisms to form inorganic substances, passed through serial procedures of a precipitation tank and a bio-tank to produce metabolic products of various microorganisms, decomposition products of organic substances, chelate products of resynthesis products, caking material, which are then macromolecularized through aggregation, condensation, conglomeration and polycondensation, whereby the organic substances contained in the organic aqueous solution are removed while the treated water or sludge become to have strong chelate structure and the metabolic products of the microorganisms become to have strong sterilization activity and deodorization activity.

In order to produce pollution-free functional water mainly comprising metabolic products of microorganisms and resynthesis products thereof by culturing an organic aqueous solution containing organic substances and activating humification of the organic substances by humus soil and rubbles containing various inorganic substances including active silicates normally existing in the ground surface, the present invention comprises the steps of:
preparing a mixture solution of 1 to 10 weight parts of molasses powder, 0.05 to 1 weight parts of soybean powder and 0.01 to 0.5 weight parts of bamboo powder, based on 100 weight parts of raw water, in which the powders are pulverized to a size of 100 to 400 mesh;
supplying the mixture solution to an introduction tank and keeping it for 2 to 5 days while aerating;
passing the solution from the introduction tank 1 through a sieve 2 of about 100 mesh to remove impurities and macromolecularized sludge circulated from a precipitation;
subjecting the solution with impurities and sludge removed to decomposition in a decomposition tank 3 for 50 to 70 days by aerobic bacteria and facultative anaerobic bacteria which naturally habit in environment where humus substances exist;
storing the product from the decomposition tank 3 for 2 to 5 days in a first precipitation tank 5 to primarily aggregate sludge, circulating a part of the sludge to the introduction tank 1 and the decomposition tank 3, transferring the rest to a culture tank 4 filled with humus soil and active silicates, followed by cultivation for 10 to 15 days, and transferring the supernatant to a bio-tank 6 and the rest to the decomposition tank 3;
culturing the supernatant transferred to the bio-tank 6 for 20 to 30 days; and

transferring the product from the bio-tank 6 to a second precipitation tank, adding an activating agent to secondarily aggregate sludge, circulating the resulting sludge to the introduction tank 1 and transferring the supernatant to a filter supply tank 8, followed by filtering using a filter 9 to obtain functional water.

In the method for producing functional water according to the present invention, molasses, soybean and bamboo are pulverized to a size of at least 100 mesh. If they are pulverized to a size of greater than 400 mesh, economical efficiency for the effect is poor and thus, the particle size is preferably in the range of 100 to 400 mesh.

The culture tank 4 is filled with humus soil and rubbles containing various inorganic substances including active silicates normally existing in the ground surface. Therefore, in the culture tank 4, the culture sludge is activated by such environment, decomposed by microorganisms adapted to live in the activated environment, followed by gasification to form an aqueous solution along with non-gasificated residuals, metabolic products of the microorganisms and resynthesis products thereof.

The Bio-tank 6 is filled with granite rubbles and its inner wall is coated with granite tiles.

Since the method according to the present invention does not need a dehydrating process employing a flocculant such as chemicals but can remove impurities by means of a sieve and be conducted in a condensed natural environment such as that filled with humus soil and active silicates, it can be said a more environmentally friendly technology without generation of polluting substances.

Also, the humus soil introduced in the second precipitation can acts to rapidly increase activity of the organic solution and to improve deodorization and sterilization effects. The organic aqueous solution transferred from the bio-tank 6 to the second precipitation tank 7 is brownish and has a pH of 4.8 to 8.6. When humus soil is added to the second precipitation tank 7 in an about of about 3% of the organic aqueous solution while stirring, the solution becomes to have a pH of 3.5 to 4.2 and is decolorized to form a colorless solution.

According to the method of the present invention, it is possible to obtain functional water being rich in metabolic products of microorganisms prepared in decomposition of organic substances and resynthesis products such as various vitamins, antibiotics and growth promoting substances and having antibiotic and antibacterial effects against various resistant bacterial by using activating agents such as humus soil and active silicates to promote humification of organic substances and by making a natural environment in a reactor comprising an introduction tank, a bio-tank, a precipitation tank, a filter supply tank and a treatment tank to accelerate self-purification of organic substances in nature which are slowly progressed over a wide area.

### BRIEF DESCRIPTION OF THE DRAWINGS

Further objects and advantages of the invention can be more fully understood from the following detailed description taken in conjunction with the accompanying drawings in which:

FIG. 1 is a view showing the process for producing pollution-free functional water according to the present invention.

### DETAILED DESCRIPTION OF THE PREFERRED EMBODIMENTS

Now, the present invention will be described in detail through the following Examples and Experimental examples.

### EXAMPLE 1

### Preparation of Functional Water

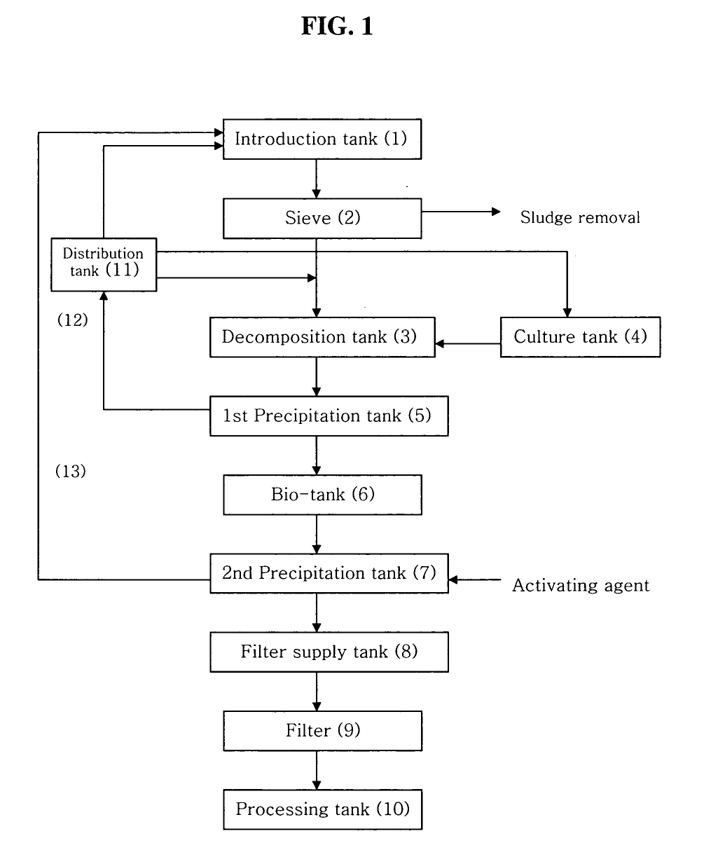

The functional water was prepared using the apparatus for producing functional water comprising an introduction tank (20.7 m³), a decomposition tank (302.4 m³), a culture tank (62.7 m³), a first precipitation tank (15.6 m³), a bio-tank (126.7 m³), a second precipitation tank (14.4 m³), a filter supply tank (11.7 m³) and treated water tank (33.5 m³) according to the production process, as shown in FIG. 1.

Firstly, 250 kg of molasses, 15 kg of soybean and 5 kg of bamboo were pulverized to a size of 100 to 400 mesh and added to 5 tone of water while stirring to prepare a mixture solution containing organic substances. The mixture solution was supplied into an introduction tank 1, and kept for 2 days while aerating by an aeration system with a low oxygen transfer rate and excellent stirring effect, passed through a sieve 2 of 100 mesh at a uniform flow rate by means of a pump to remove solid organic substances greater than 100 mesh and the organic aqueous solution was transferred to a decomposition tank 3.

The organic aqueous solution was then stored in a decomposition tank 3 for 60 days so that the organic substances can be decomposed by aerobic bacteria and facultative anaerobic bacteria which naturally habit in environment where humus substances exist, naturally flowed in a first precipitation tank 5, in which the solution was kept for 3 days to aggregate sludge and separate solid and liquid. In the decomposition tank 3, a micro bubble generating system with a high oxygen transfer rate was used and DO level was set to 0.7 ppm or less.

Then, the supernatant was transferred to a bio-tank 6 at the downstream and the solids were transferred to a distribution tank 11 to control sludge concentration in the decomposition tank. In the distribution tank 11, a part was circulated to the introduction tank 1 and the decomposition tank 3 and the rest was transferred to a culture tank 4 which is filled with humus soil and active silicates and equipped with an apparatus for aerating and cultured for 12 days while aerating. Thus, the sludge decomposed and activated by microorganisms in the culture tank 4 was again circulated to the decomposition tank 3. In the above procedure, the reason why a part of the sludge was circulated from the first precipitation tank to the introduction tank is to induce the mixture solution into environment where humus substances exist by combining with metabolic products of microorganisms having properties of polyphenolic aromatic compounds which are metabolic products of aerobic bacteria and facultative anaerobic bacteria adapted to habit in the environment where humus substances exist, and resynthesis products thereof while stirring.

The supernatant water transferred to the bio-tank 6, which has a side wall comprising a granite layer and is filled with granite rubbles was stored there for about 25 days for aging and purification, and then transferred to a second precipitation tank 7.

The organic aqueous solution transferred to the second precipitation tank 7 was then supplied to a second precipitation tank 7 while stirring with humus soil in an amount of about 3% of the transferred organic aqueous solution to form a colorless solution, which was left for 3 days to form precipitates. Solid-liquid separation was conducted to obtain the precipitates.

The precipitates obtained by the solid-liquid separation were transferred to an introduction tank 1 via a circulating line 13 and repeatedly subjected to filtration with a sieve and the supernatant was transferred to a filter supply tank 8 which was equipped with a filter 9 having a pore size of about 100 mesh, followed by filtration to obtain a physiological active solution as the final product.

### EXAMPLE 2

### Administration of Functional Water to Crops

Cultivation of vegetables belonging to Solanaceae family (eggplant, pimento and potato), cucumis melo L. var family (cucumber, melon and water melon) and gramineae family (field rice plant, barley) was conducted by diluting the vegetables in 1:1000 of the functional water according to the present invention and the results were observed. The results are as follows.

(A) Solanaceae Family (Eggplant, Pimento and Potato)

In spite of having seeded 10 days later than an optimal time for seeding on a field judged as “cultivation impossible” by difficulty in repeated cultivation, the growth was well along and it could possible to harvest 14 days earlier than the field where seeding was conducted at an optimal time.

Flowers were in good conditions and even when a large fruit after an optimal harvest time was hung on a branch, the branch was not damaged.

Upon comparison with normal raising, the type and number of blight and insect damages was small and the distribution of agricultural chemical was reduced from once per week in common to once per month.

The harvest season began early as compared to normal raising and lasted further and the number of fruit was increased and the size of fruit was bigger with fine color and high sugar content. As a result, the fruit attained strong market competitiveness. Also, tick occurrence was reduced, as compared to normal raising.

(B) Cucumis melo L. var (cucumber, melon and water melon)

The leaf drop rate was low, the fruit bearing rate was high, and the tree was not weakened but still could bear fruits even when fruits after optimal harvest time were left on the tree.

The leaf color was fine and the growth was fast.

In spite of cultivation without using any agricultural chemical, mite did not break out.

Due to a low breakout rate of mite, the administration of agricultural chemicals was reduced.

The harvest was increased and the sweetness was high.

In case of melon, the sugar content was raised by 1 to 2 degree to record 16.

In case of watermelon, the flesh showed a color of fresh fruit with yellow stems. In cultivation in a vinyl house, the sugar content recorded 12.

In case of strawberry, snail immediately disappeared without distribution of an agricultural chemical and agricultural chemical-free cultivation is possible.

(C) Gramineae (field rice plant, barley)

The leaves had strong resiliency and did not fall down until a plant height reached 12 cm.

Damage of ear blast disease was not substantially observed.

The ears were long, the number of grains reach 150 to 190, and the harvest was great with excellent savor, sweetness and glutinosity.

### EXPERIMENTAL EXAMPLE 1

### Test of Sterilization Effect of Functional Water

The functional water according to the present invention was examined for sterilization effect using E.coli and salmonella as experiment strains.

The functional water diluted in a rate of 0, 1/10 and 1/20. To 9 ml of each dilution, 1 ml of strain at 10⁶/ml was added for 0.5, 1, 2, 4 and 6 hours. 1 ml of each sample was cultured by standard agar plate cultivation (at 35° C. for 48 hours) and the result was observed. Both strains were cultured at 35° C. for 24 hours with BHI, the strain liquid was controlled by phosphate buffer and the specimen was diluted with sterilized distilled water.

The results are shown in Table 1 and Table 2. The results are shown in the number of bacteria per ml.

TABLE 1
Sterilization effect on E. coli (normal bacterial level 5.3 × 10⁶/ml)

| Dilution | Time | | | | |
|---|---|---|---|---|---|
| rate | 0.5 | 1 | 2 | 4 | 6 |
| 0 | 0 | 0 | 0 | 0 | 0 |
| 10 | ∞ | ∞ | 4,800 | 740 | 10 |
| 20 | ∞ | ∞ | ∞ | ∞ | ∞ |

TABLE 2
Sterilization effect on salmonella (normal bacterial level 2.0 × 10⁶/ml)

| Dilution | Time | | | | |
|---|---|---|---|---|---|
| rate | 0.5 | 1 | 2 | 4 | 6 |
| 0 | 0 | 0 | 0 | 0 | 0 |
| 10 | 230 | 68 | 15 | 8 | 2 |
| 20 | ∞ | ∞ | 9,200 | 3,700 | 1,600 |
| 30 | ∞ | ∞ | ∞ | ∞ | 3,100 |

### EXPERIMENTAL EXAMPLE 2

### Test of Residual Agricultural Chemical of Functional Water

The functional water prepared by the method according to the present invention was subject to a residual agricultural chemical test and the results are shown in Table 3.

TABLE 3

| | Detection | Detection limit |
|---|---|---|
| BHC | None | 0.005 ppm |
| (sum of α, β, γ and δ) | | |
| DDT | None | 0.005 ppm |
| (including DDD, | | |
| EPN | None | 0.01 ppm |
| Aldrin | None | 0.005 ppm |
| Endrin | None | 0.005 ppm |
| Dildrin | None | 0.005 ppm |
| Parathion | None | 0.01 ppm |
| Malathion | None | 0.01 ppm |

### EXPERIMENTAL EXAMPLE 3

### Analysis of Toxic Ingredients in Functional Water

The functional water prepared by the method according to the present invention was subjected to analysis of toxic ingredients such as mercury, cadmium, arsenic, cyan and PCB and the results are shown in Table 4.

TABLE 4

| | Detection | Detection limit |
|---|---|---|
| Mercury | None | 0.005 ppm |
| Cadmium | None | 0.1 ppm |
| Arsenic | None | 0.2 ppm |
| Cyan | None | 0.5 ppm |
| PCB | None | 0.005 ppm |

### EXPERIMENTAL EXAMPLE 4

### Test of Penicillin in Functional Water

The functional water prepared by the method according to the present invention was subjected to a test to examine whether containing penicillin and the results are shown in Table 5.

TABLE 5

| | Detection | Detection limit |
|---|---|---|
| Penicillin | None | 0.005 ppm |

### EXPERIMENTAL EXAMPLE 5

### Test of Removal of Offensive Odor in Waste Water Treatment Plants

At a height of 50 mm from the water surface of RBC contact tank in a waste water treatment plant, ammonia (NH₄), hydrogen sulfide (H₂S), methylmercaptane (CH₃SH) and trimethylamine ((CH₃)₃N) samples were taken before and after treatment with the functional water prepared by the method according to the present invention.

Firstly, without any treatment, the bad odor in the plant was taken, as it is, according to air pollution regulation test method.

Then, the bad odor was introduced into a previously manufacture reaction tank of W400×L400×H400 (0.064 liter) and the functional water prepared by the method according to the present invention was prayed once (1 ml) per about 20 seconds into the reaction tank using an aerosol and the smell was analyzed using an equal amount and method. The results are shown in Table 6.

TABLE 6

| | Allowable exhaust standard | | | | | |
|---|---|---|---|---|---|---|
| | Plant in | | Plant in | | Odor analysis | |
| | industrial | | other | | Before | After |
| | region | | regions | | treatment | treatment |
| Ammonia (NH₄₎ | Up to 2 | ppm | Up to 1 | ppm | 4.57 ppm | 0.402 ppm |
| Hydrogen sulfide | Up to 0.06 | ppm | Up to 0.02 | ppm | 0.16 ppm | 0.009 ppm |
| (H₂S) | | | | | | |
| Methylmercaptane | Up to 0.004 | ppm | Up to 0.002 | ppm | 4.841 ppm | Not-detected |
| (CH₃SH) | | | | | | |
| Trimethylamine | Up to 0.02 | ppm | Up to Up to 0.005 | ppm | 0.008 ppm | Not-detected |
| ((CH₃)₃N) | | | | | | |

The functional water produced by the self-purification method according to the present invention is rich in both metabolic products of microorganisms prepared in decomposition of organic substances and resynthesis products such as various vitamins, various humic acids, substances having aromatic properties, growth promoting substances and antibiotics, and has antibiotic and antibacterial effects against various resistant bacterial.

The functional water prepared according to the present invention has sterilization activity and deodorization activity at the same time can be effectively used in sterilization and deodorization of public places such as hospitals, subways, trains, airplanes, theaters, offices and work places.

By applying the functional water according to the present invention to fishery, it is possible to increase taste and freshness of fish without addition of any antibiotic to feed.

The functional water according to the present invention can also be used as a food additive substituting a preservative as well as a detergent for fruits and vegetables.

Since the functional water according to the present invention and the sludge have strong sterilization effects on harmful bacteria, when it is administered to a cattle shed, pathogenic bacteria of the cattle shed can be sterilized and useful bacteria thus can be dominated. Also, since it has a strong chelating structure, it can be usefully used to remove offensive odor of cattle sheds by forming coordination compounds and resistant coordination compounds with NH₄ or H₂S molecule which is a main cause of bad odor of cattle sheds.

By applying the functional water according to the present invention to plants, it is possible to promote growth of the plants and to prevent blight and insect damage without using an additional chemical fertilizer or agricultural chemical.

It is appreciated by those skilled in the art that various changes and modifications can be made to the illustrated embodiments without departing from the spirit of the present invention. All such modifications and changes are intended to be covered by the appended claims.

1. A method for producing functional water comprising the steps of:
preparing a mixture solution of 1 to 10 weight parts of molasses powder, 0.05 to 1 weight parts of soybean powder and 0.01 to 0.5 weight parts of bamboo powder, based on 100 weight parts of raw water, in which the powders are pulverized to a size of 100 to 400 mesh;
supplying the mixture solution to an introduction tank and keeping it there for 2 to 5 days while aerating;
passing the solution from the introduction tank through a sieve with a pore size of about 100 mesh to remove impurities and macromolecularized sludge circulated from a precipitation tank;
subjecting the solution with impurities and sludge removed to decomposition in a decomposition tank for 50 to 70 days by aerobic bacteria and facultative anaerobic bacteria which naturally habit in environment where humus substances exist;
storing the product from the decomposition tank in a first precipitation tank for 2 to 5 days to primarily aggregate sludge, circulating a part of the sludge to the introduction tank and the decomposition tank, transferring the rest to a culture tank filled with humus soil and active silicates, followed by cultivation for 10 to 15 days, and transferring the supernatant to a bio-tank and the rest to the decomposition tank;
culturing the supernatant transferred to the bio-tank 6 for 20 to 30 days; and
transferring the product from the bio-tank to a second precipitation tank, adding an activating agent to secondarily aggregate sludge, circulating the resulting sludge to the introduction tank and transferring the supernatant to a filter supply tank, followed by filtration with a filter to obtain functional water.

2. The method of claim 1, wherein the bio-tank has an inner wall coated with granite tiles and is filled with granite rubbles at the inside thereof.

3. The method of claim 1, wherein the activating agent added to the second precipitation is humus soil.

4. The method of claim 2, wherein the activating agent added to the second precipitation is humus soil.
